(19) United States
(12) Patent Application Publication
(10) Pub. No.: US 2026/0278448 A1
(43) Pub. Date: Sep. 17, 2026

(54) SYSTEM AND METHOD FOR ENHANCING VARIATIONAL QUANTUM IMAGINARY TIME EVOLUTION FOR GRAPH PARTITIONING WITH A MODIFIED FIDUCCIA-MATTHEYSES ALGORITHM

(71) Applicant: IonQ, Inc., College Park, MD (US)

(72) Inventors: Daiwei ZHU, Seattle, WA (US); Guillermo ABOUMRAD, Hollywood, FL (US); Ananth KAUSHIK, Santa Clara, CA (US); Claudio GIROTTO, Salt Lake City, UT (US); Martin ROETTELER, Woodinville, WA (US)

(21) Appl. No.: 19/568,411

(22) Filed: Mar. 16, 2026

Related U.S. Application Data
(60) Provisional application No. 63/772,312, filed on Mar. 14, 2025.

(51) Int. Cl. G06N 10/60

(52) U.S. Cl. CPC G06N 10/60

(57) ABSTRACT

A system and method are provided for performing a quantum-classical hybrid approach for graph partitioning. The method comprises converting a graph partitioning problem with a constraint into a quadratic unconstrained binary optimization (QUBO) formulation; encoding the QUBO formulation as a cost Hamiltonian for execution on a quantum processing unit (QPU); applying variational quantum imaginary time evolution (VarQITE) to the QUBO formulation to evolve a quantum state representing candidate solutions for the graph partitioning problem; sampling partitions from the quantum state; refining the candidate solutions by inputting the sampled partitions into a modified Fiduccia-Mattheyses (FM) algorithm; and outputting optimized graph partitions from the modified FM algorithm for downstream applications.

### CROSS REFERENCE TO RELATED APPLICATIONS

The current application claims priority to U.S. Patent Provisional Application No. 63/772,312, filed Mar. 14, 2025, the entire contents of which are hereby incorporated by reference.

### TECHNICAL FIELD

Aspects of the present disclosure relate generally to systems and methods for performing graph partitioning, and more specifically, to a method of integrating a quantum optimization algorithm with classical heuristic methods to solve graph partitioning problems.

### BACKGROUND

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, control, and/or functionality of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of systems and methods for solving a graph partitioning problem, particularly under nodal weight balance constraints, by integrating quantum and classical optimization techniques. In particular, the present disclosure combines variational quantum imaginary time evolution (VarQITE) and a modified Fiduccia-Mattheyses (FM) algorithm to achieve more efficient and effective partitioning compared to either approach used alone. The present disclosure describes a hybrid approach that is particularly beneficial for graph partitioning with additional constraints such as those found in finite element simulations. In particular, the present disclosure offers a practical quantum-classical solution that can be implemented on quantum computing hardware.

In some aspects, the techniques described herein relate to a method for performing a quantum-classical hybrid approach for solving graph partitioning problems, the method comprising: converting a graph partitioning problem with a constraint into a quadratic unconstrained binary optimization (QUBO) formulation; applying VarQITE to the QUBO formulation to evolve a quantum state representing candidate solutions for the graph partitioning problem; sampling partitions from the quantum state; refining the candidate solutions by inputting the sampled partitions into a modified Fiduccia-Mattheyses (FM) algorithm; and outputting optimized graph partitions from the modified FM algorithm for downstream applications.

In some aspects of the present disclosure, a system is configured to perform a quantum-classical hybrid approach for solving graph partitioning problems. The system includes at least a pre-processor configured to: convert a graph partitioning problem with a constraint into a QUBO formulation; apply VarQITE to the QUBO formulation to evolve a quantum state representing candidate solutions for the graph partitioning problem; sample partitions from the quantum state; refine the candidate solutions by inputting the sampled partitions into a modified FM algorithm; and output optimized graph partitions from the modified FM algorithm for downstream applications.

In one exemplary aspect, a non-transitory computer-readable medium is provided storing a set of instructions thereon for performing a quantum-classical hybrid approach for solving graph partitioning problems, the non-transitory computer-readable medium storing instructions for: converting a graph partitioning problem with a constraint into a QUBO formulation; applying VarQITE to the QUBO formulation to evolve a quantum state representing candidate solutions for the graph partitioning problem; sampling partitions from the quantum state; refining the candidate solutions by inputting the sampled partitions into a modified FM algorithm; and outputting optimized graph partitions from the modified FM algorithm for downstream applications.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions in a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates an example of an execution flow chart of a graph partitioning problem with calls to a quantum computer with aspects of this disclosure.

FIG. 5 illustrates an example method for performing a quantum-classical hybrid approach for solving graph partitioning problems in accordance with aspects of this disclosure.

FIG. 6 illustrates example comparison results of performing VarQITE, FM, and the quantum-classical hybrid approach for solving graph partitioning problems in accordance with aspects of this disclosure.

FIG. 7A-D illustrates example distribution results of performing VarQITE, FM, and the quantum-classical hybrid approach for solving graph partitioning problems in accordance with aspects of this disclosure.

FIG. 8 presents an example of a QIP system in accordance with aspects of this disclosure.

Like reference numbers and designations in the various drawings indicate like elements.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well-known components.

Graph partitioning is a fundamental computational problem with broad applications in areas such as parallel computing, Very Large-Scale Integration (VLSI) design, data clustering, and more. Its core objective is to partition the vertices of an undirected graph into two sets to minimize the number (or total weight) of edges crossing between these sets. While exact algorithms can theoretically guarantee globally optimal solutions, they often require exponential runtime, making them impractical for large-scale problems. Consequently, various heuristic algorithms have been developed that efficiently produce approximate solutions suitable for most practical purposes.

However, in many real-world scenarios, additional constraints further complicate the partitioning task, often pushing even powerful classical heuristics to their limits. A notable example arises in finite element simulations, where nested dissection plays a critical role. Nested dissection is a divide-and-conquer algorithm used to efficiently reorder sparse matrices for solving large systems of linear equations. Here, the partitioning problem must account for nodal weight balance, requiring not only a minimal weighted edge cut but also balanced vertex weights. Thus, finding an optimal partition under these conditions remains a significant challenge.

The present disclosure introduces a novel hybrid approach that integrates a quantum optimization algorithm with classical heuristic methods to solve graph partitioning problems under nodal weight balance. Specifically, the global search capability of a Variational Quantum Imaginary Time Evolution (VarQITE) is combined with the local refinement efficiency of classical heuristics. By leveraging the complementary strengths of both techniques, this framework overcomes the inherent limitations of each method and significantly improves partitioning performance.

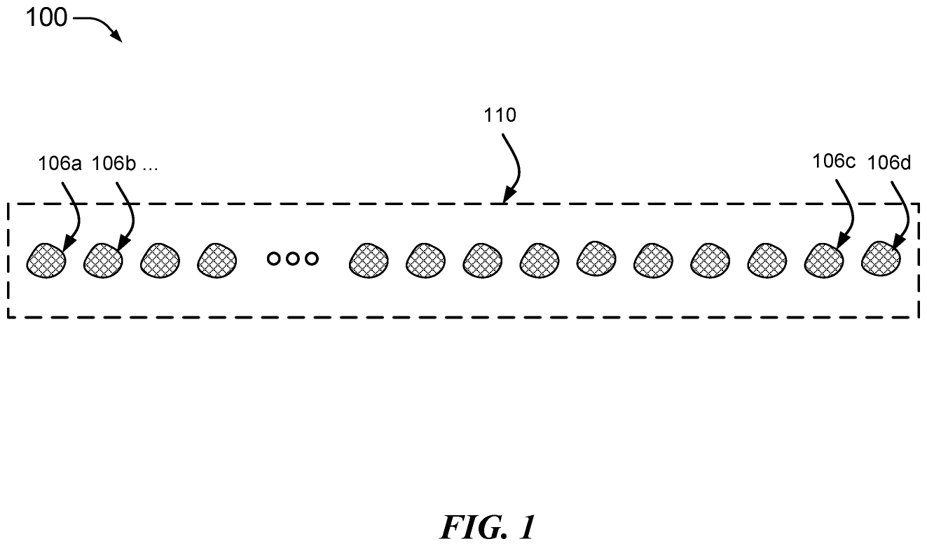

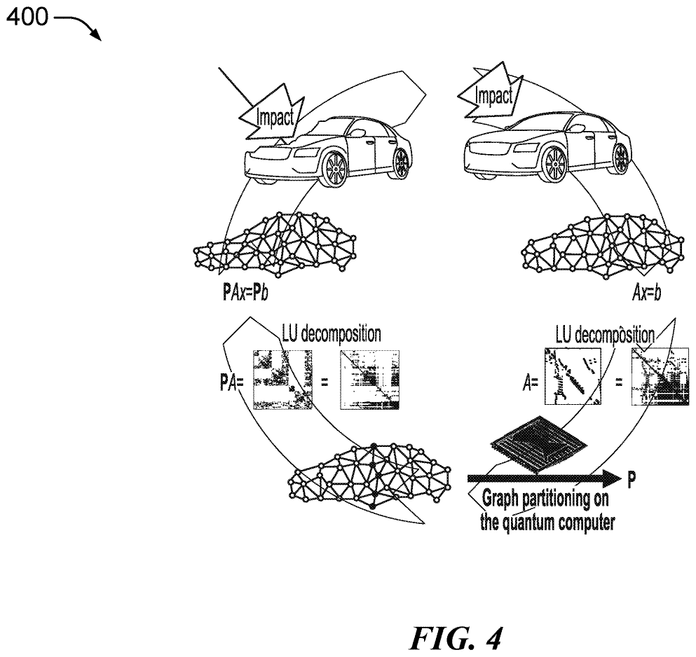

Solutions to the issues described above are explained in more detail in connection with FIGS. 1-8, with FIGS. 1-3 and 8 providing a general description of an exemplary QIP system or quantum computer, FIGS. 4-7D provide descriptions and examples of systems and methods for performing a quantum-classical hybrid approach for solving graph partitioning problems. Unlike approaches that rely solely on either classical heuristics or quantum optimization techniques, the present disclosure integrates a VarQITE algorithm with a modified FM algorithm to leverage the strengths of both methods. In this hybrid approach, the quantum algorithm explores the broader solution space while the modified FM algorithm performs classical refinement of candidate partitions under nodal weight balance constraints. As a result, the framework improves partition quality and enables more practical use of quantum resources for graph partitioning problems.

As used herein, the term “modified FM algorithm” refers to a variant of the conventional FM algorithm that differs from the standard FM algorithm in at least the following respects: (1) instead of alternating node selections between the two partitions, the algorithm identifies the partition P[b] having the greater total nodal weight and selects nodes exclusively from that partition for potential movement; (2) at each iteration, the algorithm computes a gain value D[v] for each unlocked node v in the overweighted partition, where D[v]=>Σ_{{u∈N(v)} w(v,u)}×(1−2·same_partition(u,v)), and selects the node with the highest gain value for movement to the other partition; (3) after each node movement, the gain values of neighboring nodes are updated and the moved node is locked for the remainder of the current pass; and (4) the algorithm terminates when no further improvement in cost is observed or a predetermined iteration limit is reached. The modified FM algorithm may operate in a first mode, in which a weight balance constraint is enforced at the end of each round and the algorithm reverts to the best valid configuration if no improvement satisfying the constraint is found, or a second mode, in which a composite cost function cost=C₁+p·C₂ is used, where C₁ represents the edge-weight sum and C₂ represents the violation of the nodal weight balance constraint scaled by a factor p, and all swaps are considered valid regardless of strict balance enforcement.

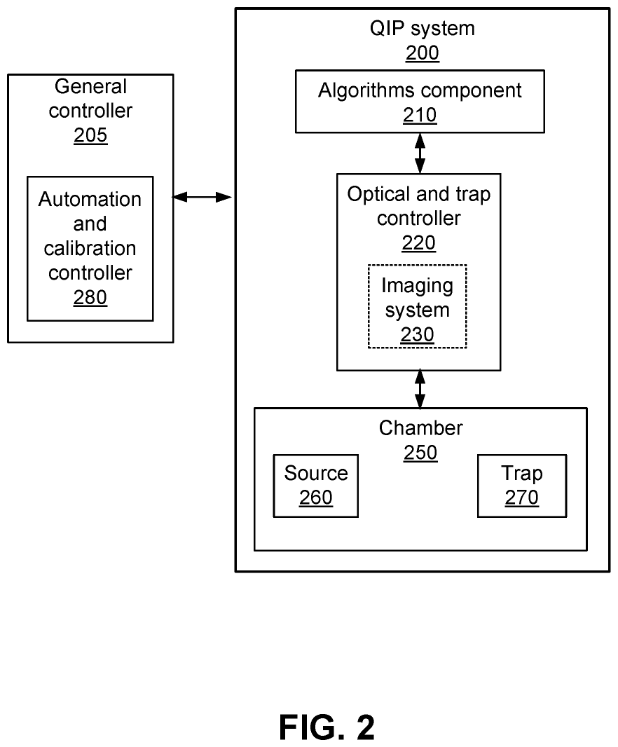

FIG. 1 illustrates a diagram 100 with multiple atomic ions or ions 106 (e.g., atomic ions 106a, 106b, . . . , 106c, and 106d) trapped in a linear crystal or chain 110 using a trap (the trap can be inside a vacuum chamber as shown in FIG. 2). The trap may be referred to as an ion trap. The ion trap shown may be built or fabricated on a semiconductor substrate, a dielectric substrate, or a glass die or wafer (also referred to as a glass substrate). The atomic ions 106 may be provided to the trap as atomic species for ionization and confinement into the chain 110. Some or all of the ions 106 may be configured to operate as qubits in a QIP system.

In the example shown in FIG. 1, the trap includes electrodes for trapping or confining multiple atomic ions (e.g., a plurality of ions) into the chain 110 that are laser-cooled to be nearly at rest. The number of atomic ions (N) trapped can be configurable and more or fewer atomic ions may be trapped. The atomic ions can be Ytterbium ions (e.g., 171Yb+ ions), for example. The atomic ions are illuminated with laser (optical) radiation tuned to a resonance in 171Yb+ and the fluorescence of the atomic ions is imaged onto a camera or some other type of detection device. In this example, atomic ions may be separated by about 5 microns (μm) from each other, although the separation may be smaller or larger than 5 μm. The separation of the atomic ions is determined by a balance between the external confinement force and Coulomb repulsion and does not need to be uniform. Moreover, in addition to atomic Ytterbium ions, neutral atoms, Rydberg atoms, different atomic ions or different species of atomic ions may also be used. The trap may be a linear RF Paul trap, but other types of confinement may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

As will be described in detail below, and according to an exemplary aspect, the ions in the ion trap can be configured by applying a laser (e.g., a Raman configuration) to one or more of the plurality of qubits to set a probability of a single event by rotating the one or more qubits to fix a relative angle of the at least one qubit. These details will be described below.

FIG. 2 is a block diagram that illustrates an example of a QIP system 200 in accordance with various aspects of this disclosure. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations.

Shown in FIG. 2 is a general controller 205 configured to perform various control operations of the QIP system 200, including the methods and algorithms described herein. These control operations may be performed by an operator, may be automated, or a combination of both. Instructions for at least some of the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200. These calibration, testing, and automation operations may involve, for example, all or part of an algorithms component 210, all or part of an optical and trap controller 220 and/or all or part of a chamber 250.

The QIP system 200 may include an algorithms component 210 that may operate with other parts of the QIP system 200 to perform quantum algorithms or quantum operations, including a stack or sequence of combinations of single qubit operations and/or multi-qubit operations (e.g., two-qubit operations) as well as extended quantum computations. The algorithms component 210 may also include software tools (e.g., compilers) that facilitate such performance or implementation. As such, the algorithms component 210 may provide, directly or indirectly, instructions to various components of the QIP system 200 (e.g., to the optical and trap controller 220) to enable the performance or implementation of the quantum algorithms, quantum applications, or quantum operations. The algorithms component 210 may receive information resulting from the performance or implementation of the quantum algorithms, quantum applications, or quantum operations and may process the information and/or transfer the information to another component of the QIP system 200 or to another device (e.g., an external device connected to the QIP system 200) for further processing.

The QIP system 200 may include an optical and trap controller 220 that controls various aspects of a trap 270 in a chamber 250, including the generation of signals to control the trap 270, and controls the operation of lasers and optical systems that provide optical beams that interact with the atoms or ions in the trap. When used to confine or trap ions, the trap 270 may be referred to as an ion trap. The trap 270, however, may also be used to trap neutral atoms, Rydberg atoms, different atomic ions or different species of atomic ions. The lasers and optical systems (e.g., optical sources) can be at least partially located in the optical and trap controller 220 and/or in the chamber 250. For example, optical systems within the chamber 250 may refer to optical components or optical assemblies. The optical and trap controller 220 can be configured to generate one or more lasers to rotate the ions and set a probability of the respective events associated with each qubit. For example, optical sources of the optical and trap controller 220 can be configured for ionization of the atomic species, control (e.g., phase control) of the atomic ions, and for fluorescence of the atomic ions that can be monitored and tracked by image processing algorithms operating in an imaging system 230, for example.

More particularly, the QIP system 200 can include an imaging system 230 that may comprise a high-resolution imager (e.g., CCD camera) or other type of detection device (e.g., photomultiplier tube or PMT) for monitoring the atomic ions while they are being provided to the trap 270 and/or after they have been provided to the trap 270. In an aspect, the imaging system 230 can be implemented separate from the optical and trap controller 220, however, the use of fluorescence to detect, identify, and label atomic ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of a processor or processing portion of the QIP system 200. That is, the trap 270 may be considered at the core of the processing operations of the QIP system 200 since it holds the atomic-based qubits that are used to perform the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the general controller 205, the automation and calibration controller 280, and/or the algorithms component 210. These and/or components of the QIP system 200 may be used in connection with the techniques for performing a quantum-classical hybrid approach for solving graph partitioning problems.

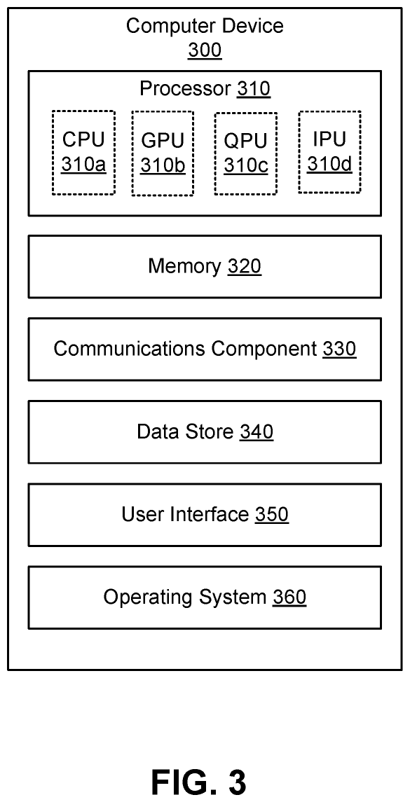

FIG. 3 illustrates an example of a computer system or device 300 in accordance with aspects of the disclosure. The computer device 300 can represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single or multiple set of processors or multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300).

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

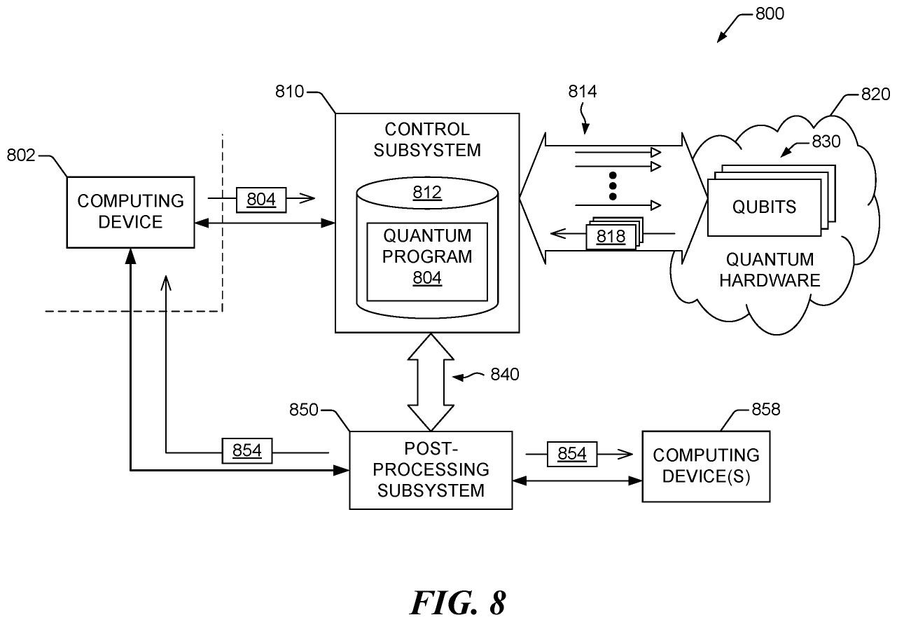

In connection with the systems described in FIGS. 1-3 and 8, and with further details provided in FIGS. 4-7D, the present disclosure provides various aspects of implementing a hybrid quantum-classical method for solving a class of graph partitioning problems with nodal balance constraints by integrating quantum and classical optimization techniques. Specifically, the present disclosure describes a hybrid method that combines VarQITE and a modified FM algorithm to achieve more efficient and effective partitioning. FIGS. 2 and 3 provide an overview of the QIP system and its computational architecture, including components like the general controller, quantum processors, and memory modules. FIG. 4-7D build upon this by illustrating how a workflow integrates both quantum and classical techniques to solve graph partitioning problems, which benefits from both the quantum computer's global search power and the modified FM algorithm's local refinement capabilities. FIG. 8 describes an exemplary QIP system or quantum computer on which aspects of the present disclosure may be implemented. Together, these figures describe the system-level claims with detailed operational workflows, highlighting the ability to integrate a quantum optimization algorithm with classical heuristic methods to solve graph partitioning problems.

A central challenge in graph partitioning is how to partition the vertices of a graph while minimizing an objective function such as the number of cut edges, and, under some constraints, such as having balanced partitions. No polynomial time algorithm can obtain balanced graph partitions within a finite approximation factor unless P=NP, and thus it is widely believed to require computational resources that scale exponentially with problem size in the worst case. Nevertheless, a range of heuristic algorithms have been developed that can efficiently produce effective solutions in practical settings.

Given a vertex and edge-weighted graph G=(V, E), a k-way partition of the graph is a family of disjoint subsets V₁, V₂, . . . , Vₖ of V such that V₁ [symbol] V₂ [symbol] . . . [symbol] Vₖ=V. When k=2, this is referred to as a bipartition. Different graph partition problems can be formulated based on the objective function to minimize and constraints placed on the partition. A typical objective function is to minimize the sum of the weights of cut edges (e.g., edges which connect vertices belonging to different parts) ((vᵢ,vⱼ)∈E with vᵢ∈Vᵢ, vⱼ∈Vⱼ, i≠j). A typical constraint may be to enforce that the parts have equal or similar sizes. In the context of multilevel Nested Dissection, there is freedom in the choice of the constraints. The goal is to find a bipartition {V₁, V₂} such that |V₁| and |V₂| do not exceed (½+v)|V| where |·| denotes the sum of vertex weights.

In order to leverage quantum resources for solving the graph partitioning problem, the quantum problem may be formulated as a Quadratic Unconstrained Binary Optimization (QUBO). Standard techniques convert inequality constraints into penalty terms by introducing slack variables. This translates into higher qubit requirements when minimizing on quantum hardware, therefore the following penalty formulation is used instead:

$$P ( x ) = {( {\sum }_{i} {v}_{i} {x}_{i} - {\sum }_{i} \frac{{v}_{i}}{2} )}^{2} .$$

The quadratic term penalizes deviations in the total node weight on each side of the partition such that it is minimized when the sum of the node weights in S and T are equal. Accordingly, the problem is to minimize the unconstrained objective.

$$C ( x ) = {\sum }_{( i , j ) ϵ E} {w}_{ij} ( {x}_{i} + {x}_{j} - 2 {x}_{i} {x}_{j} ) + λ P ( x ) .$$

Here λ is a hyper-parameter defining the trade-off between lower weight and more balanced cuts which can be tuned.

As used herein, “a graph partitioning problem with a constraint” refers to a graph partitioning problem in which, in addition to minimizing an objective function such as the sum of edge weights crossing the partition boundary, the partition must satisfy one or more additional requirements imposed on the resulting subgraphs. In an exemplary embodiment, the constraint is a nodal weight balance constraint requiring that the total vertex weight on each side of the partition does not exceed (½+v)|V|, where |V| denotes the sum of all vertex weights in the graph and v is a tolerance parameter (e.g., 5%). To incorporate the constraint into a QUBO formulation, the constraint is converted into a quadratic penalty term of the form λ·(Σ{i∈V₁} w_i−Σ{j∈V₂} w_j)², which penalizes deviations in total node weight between the two partitions and is minimized when the weight sums are equal. The hyperparameter λ defines the trade-off between minimizing edge-cut cost and enforcing the balance constraint and may be tuned based on the specific problem instance. Other constraints, such as cardinality constraints requiring equal numbers of vertices in each partition, or connectivity constraints requiring that each partition induces a connected subgraph, may also be converted into penalty terms using analogous quadratic penalty techniques and incorporated into the QUBO formulation.

The present disclosure explores using quantum algorithms to obtain higher quality graph partitions by exploiting quantum resources to improve upon leading classical heuristics. In particular, the present disclosure describes utilizing a VarQITE algorithm for approximately solving multiple graph partitioning problems and using a modified FM algorithm to perform local refinement.

The VarQITE is a hybrid quantum-classical algorithm that approximates ground states by simulating imaginary time evolution within a variational framework. Rather than directly implementing the full imaginary time operator—often impractical for near-term quantum hardware—it employs a parameterized quantum circuit whose parameters are iteratively adjusted to replicate imaginary time dynamics. This process refines an initial trial state, progressively lowering its energy until it converges to the ground state of the target Hamiltonian. While VarQITE requires relatively fewer quantum resources compared to other quantum algorithms, its application to large-scale problems remains challenging with current hardware, highlighting the potential benefits of classical enhancements.

The FM algorithm is a well-known heuristic for graph partitioning, particularly in VLSI design. It aims to divide a graph into two balanced subsets while minimizing the number or total weight of cut edges, or “cut size,” that connect them. The algorithm iteratively swaps nodes between partitions, guided by a gain metric that quantifies the impact of each move on the overall cut size. By strategically selecting swaps that maximize improvement, FM efficiently refines partitions, making it a widely used technique in circuit design and other large-scale optimization problems.

In its standard form, the FM algorithm initializes a partition with equal cardinality and improves it through an iterative swapping process. At each step, a node is selected from one partition based on a largest gain function value and moved to the other partition. The algorithm alternates between partitions, ensuring an equal number of moves from both sides. This process continues for a maximum of M iterations or until no further improvement is observed. While this alternating strategy maintains cardinality balance, it is unsuitable for applications where nodal weight balance is a constraint.

Given a graph G(V,E), the FM algorithm seeks partitions with near-minimal edge cut through a local search strategy based on the Gain function D[v], which can be computed efficiently:

$$D [ v ] = {\sum }_{u ∈ 𝒩 ( v )} w ( v , u ) \cdot {( - 1 )}^{same \_ partition ( u , v )}$$

Where N(v) is the set of neighbors of vertex v, w(v, u) is the edge weight of the edge connecting vertices (u,v), and same_partition (u,v) is a Boolean function indicating whether the two vertices belong to the same graph partition.

To address this limitation, the present disclosure introduces a modification to the FM algorithm. At each step, the algorithm identifies the partition with the greater nodal weight P[b], where b represents the weight difference between P0 and P1.

$$P [ b ] = \{ \begin{matrix}{P}_{0} , & b \geq 0 \\ {P}_{1} , & b < 0\end{matrix}$$

Instead of alternating between partitions, nodes are always removed from the partition with the greater total nodal weight. This modification ensures that every move contributes to reducing both edge cut and nodal-weight imbalance, rather than maintaining equal cardinality.

As will be explained in more detail below, the present disclosure describes modifying the FM algorithm for the graph partitioning problem with a nodal weight balance constraint. In another aspect, the present disclosure describes modifying the FM algorithm that may adjust a weight between the edge-cut cost and the weight balance constraint. The modified FM serves as an efficient post-processing step to refine the ensemble of partitions generated by VarQITE. Its local search mechanism complements the global optimization of VarQITE by efficiently exploiting high-quality regions in the solution space. This hybrid quantum-classical approach accelerates convergence toward near-optimal solutions, enhancing both the utility of the quantum algorithm and overall computational efficiency. Additionally, it acts as an effective error mitigation strategy for quantum computers, improving the reliability of results from noisy quantum hardware.

The calculations required for quantum-classical hybrid graph partitioning, particularly those leveraging VarQITE and the modified FM algorithm, are computationally impractical to perform manually. These computations involve high-dimensional mathematical transformations, iterative optimizations, and probabilistic sampling, all of which demand computational resources that vastly exceed human cognitive capabilities.

Firstly, the problem is framed as a Quadratic Unconstrained Binary Optimization (QUBO) problem, which involves encoding a graph partitioning objective function into a Hamiltonian. This Hamiltonian is represented using quantum mechanical principles, incorporating penalty terms to enforce balance constraints on the resulting subgraphs. The translation of this problem into a quantum computational basis using Pauli operators alone requires handling an exponential number of terms, something that is computationally infeasible without digital or quantum assistance.

Secondly, the VarQITE algorithm iteratively updates the parameters of a quantum circuit to simulate imaginary time evolution, ultimately minimizing the target Hamiltonian. This involves maintaining and updating complex probability amplitudes across an exponentially large Hilbert space, which grows exponentially with the number of qubits. The human brain lacks the capacity to track and compute such high-dimensional transformations efficiently, and performing these calculations manually would require an immense amount of time, even for small instances of the problem.

Moreover, even if one were to theoretically track the quantum evolution by hand, the next stage—sampling from the evolved quantum state—requires interpreting measurement results from a quantum superposition, which is inherently probabilistic. Each measurement collapses the quantum state into a bitstring representing a candidate graph partition, but these need to be processed statistically over numerous trials to extract meaningful solutions. Such large-scale probabilistic sampling and statistical inference are infeasible without computational tools.

Following quantum computation, the output bitstrings serve as inputs to the modified FM algorithm, which applies an adaptive heuristic search. The algorithm dynamically adjusts gain metrics, iteratively selects and swaps nodes between partitions, and applies an adaptive weight factor to balance between edge-cut cost and nodal weight distribution. These iterative refinements require continuous tracking of changing variables, local optimizations, and global cost evaluations, all of which are computationally intensive even for modern digital computers.

Accordingly, the present disclosure describes a hybrid approach for graph partitioning with additional constraints, such as those found in finite element simulations. The present disclosure presents a significant advancement in hybrid quantum computing by effectively combining quantum-classical variational algorithms (e.g., VarQITE) with classical optimization techniques (e.g., one of the modified FM algorithms) to improve complex graph partitioning problems.

VarQITE may be implemented to solve a graph partitioning problem arising in a variety of engineering applications. As a non-limiting example, the graph partitioning problem may be applied to a vehicle roof crushing problem having graphs with millions of vertices and edges that need to be coarsened to manageable sizes for analysis by the quantum algorithm. Specifically, the roof crush problem may have 600,000 vertices, 5,000,000 edges, and a 2.5D shell-type mesh.

FIG. 4 illustrates an example of an execution flow chart of a graph partitioning problem with calls to a quantum computer with aspects of this disclosure. Specifically, FIG. 4 shows an execution flow chart of a general-purpose, multiphysics simulation software package used for simulating a nonlinear response of structures to various types of loading with calls to a quantum computer.

The model of the car is meshed with a finite element mesh. This provides the linear system of Ax=b. The matrix A is a sparse matrix which when decomposed using LU decomposition produces the dense matrices shown in FIG. 4. P is the permutation matrix computed to reorder the matrix A obtained by solving the graph partitioning recursively. The reordered matrix A retains a sparse structure after LU decomposition. The linear system is now solved using the reordered matrix A and vector b to obtain the required simulation of the original model problem.

The multiphysics simulation software package uses nested dissection to reduce the matrix representation of the mesh (which is represented as a graph via its adjacency matrix) to smaller chunks. The number of levels of nested dissection required can be set as a parameter in the multiphysics simulation software package control card. The tool then performs a graph coarsening to reduce the size of the graph. The degree of coarsening required (e.g., number of vertices of the coarse graph) may also be set as a parameter of the tool. The coarse graph has vertices and edges with very large vertex and edge weights due to the high degree of coarsening required so that the problem can fit on a quantum computer.

The graph partitioning problem is now formulated to find the optimal bi-partition of the graph that minimizes edge cut cost while maintaining a balanced nodal weight distribution between the two subgraphs (e.g., within 5% nodal weight balance). This optimization problem is solved using a hybrid quantum-classical approach on a quantum simulator and/or Quantum Information Processing (QIP) system (e.g., QIP system 200) utilizing the VarQITE algorithm. The coarse graph representation is encoded into a quantum Hamiltonian where qubits represent nodes, and entangling gates enforce connectivity constraints based on edges. The quantum processor, such as a superconducting qubit system or a trapped-ion platform, executes a parameterized quantum circuit (PQC) that iteratively evolves towards an optimal solution. The VarQITE algorithm operates within a quantum-classical feedback loop, where quantum measurements guide classical optimization (e.g., gradient descent, L-BFGS) to refine the quantum state. The final output is a probability distribution of bitstrings, each representing a potential graph partition, from which the optimal partition is selected through classical post-processing. This implementation follows a structured execution flow: preprocessing the graph on classical hardware, mapping it onto a quantum circuit, executing the circuit on quantum hardware, interpreting bitstring results, and refining the partition if necessary. By leveraging quantum resources for combinatorial optimization while utilizing classical computing for preprocessing and result interpretation, this approach ensures an efficient and scalable solution for complex graph partitioning tasks.

The best “edge” separator produced by solving the graph partitioning problem is then used to produce a “vertex” separator-first for the coarse graph and then refined on the fine graph. The nodes in the vertex separator are removed from the fine graph thereby splitting the fine graph into three sets: part A, part B, and the separator set (e.g., “re-ordering” at this level). Part A and B are disconnected, and the process begins again by breaking up each of Part A and Part B into two disconnected parts.

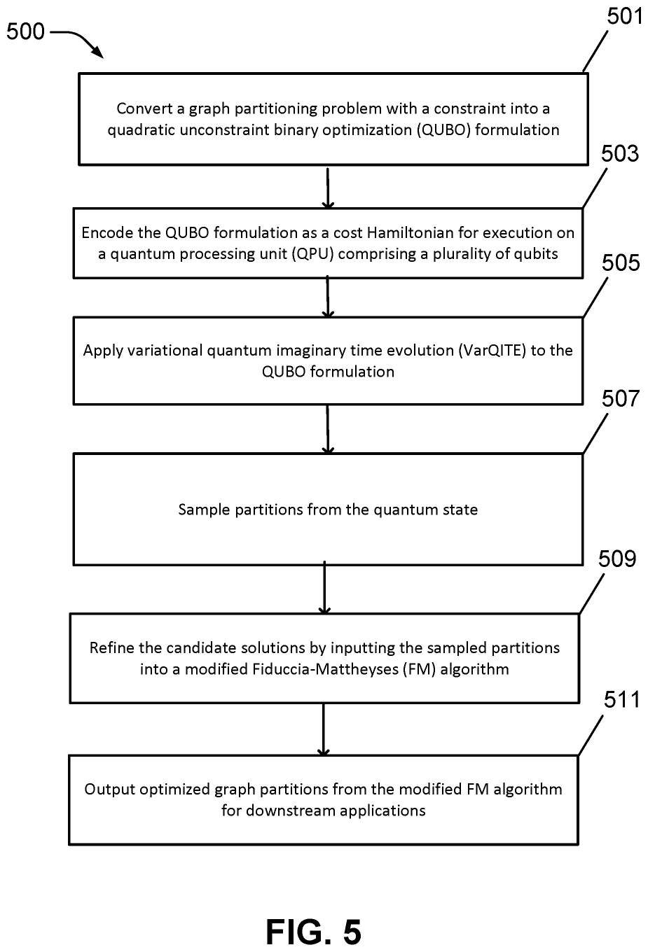

FIG. 5 illustrates an example method for performing a quantum-classical hybrid approach for solving graph partitioning problems in accordance with aspects of this disclosure. In general, it is noted that parts of the exemplary method 500 can be implemented using the components and systems described herein, especially with respect to QIP system 200 and general controller 205 of FIG. 2 as described above and system 800 and computing device 802 of FIG. 8. The steps and algorithms described in relation to method 500 may be executed by processor 310 using algorithms component 210. Specifically, the method 500 in FIG. 5 describes a method of performing a quantum-classical hybrid approach for solving graph partitioning problems.

At 501, the method 500 may include converting, by a classical processor, a graph partitioning problem with a constraint (e.g., nodal weight balance constraint) into a QUBO formulation, making it suitable for quantum processing. As an example, referring back to FIGS. 1-3, the operation at 501 may be executed within the algorithms component 210 of the QIP system 200, which interfaces with classical computing resources of the computer device 300. At 501, a classical processor (e.g., CPU 310a) may convert a graph partitioning problem subject to constraints, such as a nodal weight balance constraint, into a QUBO formulation. The resulting QUBO representation can then be provided by the algorithms component 210 to the optical and trap controller 220 or other control subsystems for mapping onto qubit operations performed by ions 106 confined in the trap 270. In this manner, the classical preprocessing performed by the processor 310 prepares the optimization problem in a form compatible with quantum processing, enabling subsequent quantum operations on the trapped-ion qubits 106 arranged in the ion chain 110.

As explained above, QUBO is a mathematical optimization framework used for solving combinatorial problems, particularly in quantum computing and heuristic optimization methods. It involves minimizing (or maximizing) a quadratic function of binary variables, expressed as min ΣiQiixi+Σi<jQijxixj, where xi∈{0, 1} and Q is a square matrix defining linear and interaction coefficients. Despite being “unconstrained,” constraints are incorporated as penalty terms within the objective function. QUBO has the ability to transform complex problems into a single quadratic expression making it a valuable tool for both classical and emerging quantum solvers.

The conversion of the constrained graph partitioning problem into a QUBO formulation at step 501 enables the problem to be processed by quantum computing hardware. In this formulation, binary decision variables representing node assignments are mapped to qubit states, and both the objective of minimizing edge-cut cost and the nodal weight balance constraint are expressed within a single quadratic function. The balance constraint is incorporated as a quadratic penalty term, such as λ(Σ wᵢxᵢ−Σ wⱼxⱼ)², thereby avoiding the need for additional slack variables that would increase qubit requirements. This compact representation allows the problem to be translated into a cost Hamiltonian suitable for quantum optimization algorithms, including variational quantum methods used in the disclosed hybrid quantum-classical workflow.

In some aspects, the graph partitioning problem may be applied to nested dissection in finite element simulations, circuit partitioning in VLSI design, or data analysis clustering. The technical utility of the disclosed hybrid quantum-classical partitioning method extends across a plurality of diverse industrial and scientific domains, each characterized by specific combinatorial optimization challenges. In one or more embodiments, the method is configured for use in finite element simulations through a process of nested dissection. In this application, the system recursively partitions an adjacency-matrix graph representing a large sparse matrix to minimize “fill-in” during LU decomposition. By reducing the introduction of non-zero elements into the factorized matrix, the method yields significant technical improvements in memory efficiency and reduces the total computational overhead of the simulation. As an example referring back to FIG. 4, this utility is demonstrated in industrial-scale modeling, such as automotive structural analysis (e.g., roof crush simulations involving 600,000 vertices and 5,000,000 edges) and biomedical fluid dynamics (e.g., blood pump simulations), where the accuracy of the partition directly impacts the feasibility of the simulation workflow.

In another embodiment, the disclosed method is applied to VLSI design for circuit partitioning. The architecture of the hybrid pipeline (specifically the classical refinement stage utilizing a version of the FM algorithm) is natively suited for partitioning integrated circuit networks into discrete functional blocks. In this context, the technical objective is to minimize signal crossings between blocks, which is essential for maintaining signal integrity, optimizing timing performance, and ensuring the manufacturability of the physical layout. By providing a more globally optimal initial partition via the quantum stage, the method enhances the effectiveness of the classical refinement in complex circuit topologies.

Furthermore, the disclosed framework is configured for data analysis and clustering, where data points are represented as nodes in a graph and edge weights represent similarity metrics. The method partitions these graphs into meaningful clusters, providing a scalable solution for datasets that grow combinatorially complex as the number of data points increases. By enumerating these diverse applications, it is demonstrated that the hybrid quantum-classical approach provides a general-purpose optimization framework rather than a narrow domain-specific tool. The method thus offers broad industrial utility by providing a unified mathematical approach to diverse problems where optimal graph partitioning is a prerequisite for system performance and resource management.

In some aspects, the QUBO formulation may include: encoding a graph partitioning objective function corresponding to the graph partitioning problem into a cost Hamiltonian; incorporating penalty terms to enforce balance constraints on partitioning subgraphs; and translating the cost Hamiltonian into a quantum computational basis using Pauli operators.

At 503, the method 500 may include encoding the QUBO formulation as a cost Hamiltonian for execution on a quantum processing unit (QPU) comprising a plurality of qubits. As an example, referring back to FIGS. 1-3, the method 500 may include encoding the QUBO formulation generated at 501 as a cost Hamiltonian for execution on a quantum processing unit (QPU 310c) of the computer device 300. In an aspect, the encoding may be performed by the algorithms component 210 operating in conjunction with the processor 310 and memory 320, which translate the QUBO coefficients into quantum operators acting on a plurality of qubits. The qubits may correspond to atomic ions 106 confined in the trap 270 within the chamber 250 of the QIP system 200. Control signals and optical operations generated by the optical and trap controller 220 may then implement the cost Hamiltonian on the trapped-ion qubits to enable subsequent quantum optimization or variational quantum processing steps. In this manner, the classical representation of the optimization problem produced by the processor 310 is transformed into a Hamiltonian representation compatible with quantum evolution of the qubit register formed by the trapped ions 106.

In this way, the system is configured to encode the QUBO formulation into a cost Hamiltonian (HC) for execution on a quantum processing unit (QPU) comprising a plurality of qubits. This transformation is achieved by constructing a Hamiltonian on n=|V| qubits such that HC|x [symbol] =C(x)|x [symbol] via the substitution xj−>(I−Zj)/2, where I represents the identity operator and Zj represents the Pauli-Z operator acting on the j-th qubit. This encoding effectively maps each binary decision variable in the QUBO directly to a physical qubit on the QPU, establishing a one-to-one correspondence between the combinatorial solution space and the Hilbert space of the quantum processor.

Because the resulting Hamiltonian is diagonal in the computational basis, its eigenvalues correspond directly to the QUBO objective function values, ensuring that the ground state of HC encodes the optimal graph partition. A significant technical advantage of expressing the Hamiltonian entirely in terms of Pauli-Z operators is that all terms commute, which enables the gradient vector required for the VarQITE update rule to be computed from a single circuit evaluation. This reduction in per-iteration cost to 2 m+1 evaluations—where m is the number of ansatz parameters—renders the algorithm practically executable on near-term, resource-constrained quantum hardware. Furthermore, this encoding unifies both the edge-cut cost objective and the nodal weight balance penalty within a single operator, allowing the QPU to simultaneously optimize both objectives during the imaginary time evolution process without the need for auxiliary constraint-handling mechanisms on the quantum device.

At 505, the method 500 may include applying VarQITE to the QUBO formulation by executing a parameterized quantum circuit on the QPU to evolve a quantum state representing candidate solutions for the graph partitioning problem. As an example, referring back to FIGS. 1-3, the method 500 may include applying VarQITE to the QUBO formulation by executing a parameterized quantum circuit on the quantum processing unit (QPU 310c) of the computer device 300. In an aspect, instructions defining the parameterized quantum circuit may be generated or coordinated by the algorithms component 210 and stored in memory 320, with execution controlled by the processor 310. The quantum circuit may be implemented on a plurality of qubits corresponding to atomic ions 106 confined within the trap 270 in the chamber 250 of the QIP system 200.

In this way, the graph partitioning problem is applied to nested dissection in finite element simulations, circuit partitioning in VLSI design, or data analysis clustering. As used herein, “applying VarQITE to the QUBO formulation” refers to the following sequence of operations: (1) the QUBO objective function, including penalty terms that penalize deviations in the total node weight on each side of the partition as described herein, is mapped to a cost Hamiltonian HC expressed in terms of Pauli-Z operators, where each binary decision variable xi in the QUBO is mapped to a corresponding qubit via the substitution x_i→(I−Zi)/2; (2) a PQC, also referred to as an ansatz, is initialized with a set of variational parameters θ to prepare an initial trial quantum state |ψ(θ) [symbol] ; (3) the circuit parameters θ are iteratively updated according to an imaginary time evolution rule derived from the Mclachlan variational principle, wherein at each iteration, the parameter update vector de/dt is obtained by solving the linear system A·(dθ/dτ)=−C, where A is the quantum Fisher information matrix with entries A_ij=Re (∂ [symbol] ψ|/∂θ_i·∂|ψ [symbol] /∂θ_j) and C is a gradient vector with entries C_i=Re(∂ [symbol] ψ/∂θ_i·H_C|ψ [symbol] ), with both A and C estimated on the quantum hardware; and (4) upon convergence or after a predetermined number of iterations, the evolved quantum state is measured in the computational basis to yield bitstrings representing candidate graph partitions.

In some aspects, step 505 includes the execution of a VarQITE algorithm, which serves as the core quantum-mechanical operation for deriving an optimal partition solution. As an example, referring back to FIGS. 1-3, during execution, the optical and trap controller 220 may generate laser pulses and control signals that perform the single-qubit and multi-qubit operations required by the parameterized circuit on the ions 106 arranged in the ion chain 110. Through iterative application of these operations and adjustment of circuit parameters by the processor 310, the quantum state of the qubits evolves under the VarQITE procedure to represent candidate solutions to the graph partitioning problem. Measurement outcomes associated with the evolved quantum state may be obtained using the imaging system 230, which detects fluorescence of the ions 106 and provides measurement data to the processor 310 or algorithms component 210 for further processing and parameter updates.

In this way, the system is configured to map the previously generated QUBO objective function to a cost Hamiltonian H expressed in Pauli-Z operators. This process involves initializing a parameterized quantum circuit, or ansatz, defined by a state |ψ(θ)) [symbol] , where Θ represents a vector of m tunable parameters. The system iteratively updates these circuit parameters according to the McLachlan variational principle, effectively simulating the evolution of the quantum state in imaginary time. This evolution drives the state |ψ(Θ) [symbol] toward the ground state of the Hamiltonian H, which is mathematically encoded to represent the optimal graph partition. By utilizing a variational framework, the method translates a complex combinatorial optimization problem into a dynamic parameter-tuning task that is natively executable on quantum hardware.

A primary technical advantage of the VarQITE approach is its ability to exponentially suppress excited-state components relative to the ground state during the evolution process. This provides a robust mechanism for converging to global or near-global optima, distinguishing it from purely classical gradient-descent-based optimizers that are frequently susceptible to becoming trapped in local minima. Furthermore, the disclosed implementation of VarQITE is specifically optimized for Near-term Intermediate-Scale Quantum (NISQ) devices. By employing shallow-depth parameterized circuits and requiring only 2 m+1 circuit evaluations per time step (where m is the number of ansatz parameters), the method achieves a significant increase in computational efficiency over traditional variational approaches. This efficiency ensures that the problem remains tractable even as the complexity of the underlying graph increases, maintaining a low qubit and gate-count overhead.

The output generated by the VarQITE algorithm at step 505 is a probability distribution peaked over optimal and near-optimal partition solutions. Unlike deterministic solvers, this probabilistic result enables the system to sample and explore a plurality of high-quality candidate solutions. In an exemplary embodiment involving a 32-node structural analysis problem, the algorithm is configured to achieve a sampling probability of approximately 26% for the absolute optimal partition, while simultaneously identifying various near-optimal alternatives. These candidates serve as the input for subsequent classical refinement, ensuring that the final output is highly refined. The application of this quantum-enhanced evolution to downstream domains (e.g., nested dissection, VLSI design, and data clustering) addresses the inherent NP-hardness of these tasks. Consequently, even modest improvements in the partition quality derived at step 505 translate into substantial, measurable reductions in computational cost, memory footprint, and wall-clock time across large-scale industrial simulation workflows.

In some aspects, applying the VarQITE may include: encoding the graph partitioning problem as a Hamiltonian minimization task; initializing a parameterized quantum circuit; iteratively updating circuit parameters using an imaginary time evolution process to minimize a target Hamiltonian; and measuring the evolved quantum state to obtain a distribution of graph partition solutions. In some aspects, initializing the parametrized quantum circuit may include preparing an initial trial quantum state using a parameterized quantum circuit and defining a cost function based on the energy expectation value of the target Hamiltonian. In some aspects, iteratively updating circuit parameters using an imaginary time evolution process may include adjusting parameters based on classical optimization techniques to minimize the cost function and refine the quantum state.

The VarQITE process comprises a structured optimization pipeline that transforms the graph partitioning problem into a cost Hamiltonian minimization task, allowing optimal solutions to be identified via energy minimization rather than exhaustive search. By initializing a shallow-depth parameterized quantum circuit and defining a cost function based on the energy expectation value of the Hamiltonian, the method facilitates execution on Near-term Intermediate-Scale Quantum (NISQ) hardware without requiring fault-tolerant resources. The pipeline iteratively updates circuit parameters via an imaginary time evolution process, which provides a distinct technical advantage by exponentially suppressing excited-state (suboptimal) components and driving the system toward a ground-state solution while mitigating the risk of entrapment in local minima prevalent in gradient-descent methods. Upon convergence, the evolved quantum state is measured to generate a probability distribution of partition solutions, providing an ensemble of high-quality candidate partitions that are subsequently refined by a downstream classical algorithm. This integrated configuration ensures a robust and scalable framework that leverages non-unitary quantum dynamics to solve complex combinatorial optimization problems with high resource efficiency.

In one exemplary embodiment, the parameterized quantum circuit (PQC) referenced in the VarQITE definition above comprises a hardware-efficient ansatz constructed from L layers, where each layer includes: (a) a set of single-qubit rotation gates RY(θ_i) and RZ(θ_i) applied to each qubit, providing local variational freedom; and (b) a set of two-qubit entangling gates (e.g., CNOT gates or CZ gates) applied between pairs of qubits corresponding to edges in the graph, thereby encoding the graph's connectivity structure into the circuit topology. The number of layers L may be selected based on the size and connectivity of the graph, with deeper circuits providing greater expressibility at the cost of increased quantum resource requirements. In another exemplary embodiment, the ansatz may be a problem-inspired ansatz in which the entangling gate topology directly mirrors the adjacency structure of the input graph.

The convergence criteria referenced in the VarQITE definition above may include one or more of the following: (i) the change in the energy expectation value [symbol] ψ(θ)|H_C|ψ(θ) [symbol] between successive iterations falls below a predetermined energy tolerance ε (e.g., ε=10⁻⁴); (ii) the norm of the parameter update vector |dθ/dτ| falls below a predetermined parameter stability threshold δ; or (iii) a maximum number of imaginary time evolution steps Tmax is reached. Classical optimization techniques such as gradient descent or L-BFGS may be used in conjunction with the Mclachlan variational principle to refine the parameter updates.

At 507, the method 500 may include sampling partitions from the quantum state by measuring the plurality of qubits of the QPU in a computational basis to obtain bitstrings representing candidate graph partitions. As an example, referring back to FIGS. 1-3, the method 500 may include sampling partitions from the quantum state by measuring the plurality of qubits of the quantum processing unit (QPU 310c) in a computational basis to obtain bitstrings representing candidate graph partitions. In an aspect, the qubits correspond to atomic ions 106 confined in the trap 270 within the chamber 250 of the QIP system 200, and the measurement may be performed after execution of the parameterized quantum circuit described above. In addition, the measurement operation may be facilitated by optical detection processes controlled by the optical and trap controller 220, which illuminate the ions 106 with laser radiation to induce state-dependent fluorescence. The emitted fluorescence may be detected by the imaging system 230, which may include a high-resolution imager or photodetection device configured to distinguish the measured states of the ions. Measurement data produced by the imaging system 230 may be communicated to the processor 310 and/or the algorithms component 210, where the detected qubit states are converted into bitstrings representing candidate graph partitions and stored in memory 320 or the data store 340 for further evaluation and optimization processing.

These sample partitions are extracted and used as initial inputs for a modified FM algorithm. As used herein, “sampling partitions from the quantum state” refers to performing repeated projective measurements of the evolved quantum state |ψ(θ) [symbol] in the computational (Z) basis to obtain a collection of bitstrings {b₁, b₂, . . . , bS}, where S is the number of measurement shots. Each bitstring bk is an n-bit string corresponding to the n qubits (and thus the n nodes of the coarsened graph), where a bit value of 0 assigns the corresponding node to a first partition V₁ and a bit value of 1 assigns it to a second partition V₂. The collection of sampled bitstrings constitutes an ensemble of candidate graph partitions whose distribution reflects the probability amplitudes of the evolved quantum state. These sampled partitions are then provided as initial partition inputs to the modified FM algorithm for classical refinement.

The sampling operation at step 507 serves as the functional interface between the quantum and classical stages, utilizing repeated projective measurements of the evolved quantum state in the computational basis to generate an ensemble of n-bit strings representing candidate graph partitions. This process transforms the continuous quantum state into discrete bitstrings, enabling the transition from an exponentially large Hilbert space to a format natively processable by classical refinement logic. Because the sampling distribution is biased toward the ground state of the cost Hamiltonian, the resulting partitions provide high-quality, quantum-informed initializations that are statistically superior to the random seeds typically utilized in conventional heuristics. This approach significantly mitigates the convergence limitations of the modified FM algorithm when navigating complex, multi-objective solution spaces, thereby accelerating the local search, enhancing overall computational efficiency, and functioning as an inherent error-mitigation mechanism for results derived from noisy quantum hardware.

At 509, the method 500 may include refining, by the classical processor, the candidate solutions by inputting the sampled partitions into a modified FM algorithm to further improve the candidate solution. As an example, step 509 integrates a modified FM algorithm to refine quantum-derived partitions, effectively combining quantum global search capabilities with classical local optimization. Unlike conventional FM implementations, the modified algorithm is configured to prioritize node selection from overweighted partitions to simultaneously minimize edge-cut costs and nodal-weight imbalance. This lightweight refinement stage operates in linear time and supports multiple modes (including a strict balance enforcement and a composite penalty function) to adapt to specific constraint requirements. By iteratively processing VarQITE-generated candidates, the modified FM refinement shifts the solution distribution toward the global optimum, yielding a higher partition fidelity than independent quantum or classical methodologies.

In some aspects, the method 500 may include iteratively executing multiple rounds of VarQITE partitioning followed by application of the modified FM algorithm. The solution is further refined by iterating multiple rounds of VarQITE and FM processing, generating an ensemble of partitions from which the lowest-cost solution is selected. This iterative feedback loop demands a significant amount of memory and computational power to maintain a history of past solutions and refine them systematically. The complexity of tracking and improving upon prior solutions across multiple quantum-classical iterations is simply impossible for manual computation.

Instead of alternating between partitions like in the FM algorithm, the modified FM algorithm ensures that nodes are always removed from the partition with the greater total nodal weight. This modification ensures that every move contributes to reducing both edge cut and nodal-weight imbalance, rather than simply maintaining equal cardinality. The modified FM algorithm refines partitions generated by VarQITE through efficient postprocessing. Its local search mechanism enhances VarQITE's global optimization by exploiting high-quality solution regions, accelerating convergence to near-optimal solutions. This hybrid quantum-classical approach improves computational efficiency and serves as an error mitigation strategy, enhancing the reliability of results on noisy quantum hardware.

In some aspects, applying the modified FM algorithm (e.g., first modified algorithm) comprises: assigning an initial gain value to each node based on a partition cost function; iteratively selecting and swapping nodes between partitions based on the improvement in edge cut to remove nodes from a partition with a greater total nodal weight; and performing a check at the end of each round to enforce the weight balance constraint.

In one or more embodiments, the first modified FM algorithm implements a convergent, iterative refinement loop configured to satisfy nodal weight balance constraints via an efficient gain metric. This metric captures the net change in edge-cut cost for individual node movements, precluding the need for a global objective re-evaluation at each step. By selectively swapping the highest-gain nodes exclusively from an overweighted partition—defined as the partition with a greater total nodal weight—to the lighter partition, the algorithm simultaneously minimizes edge-cut costs and reduces weight imbalance. This directional node-selection process achieves a dual-objective optimization that standard alternating FM heuristics cannot reliably perform.

The first modified FM algorithm executes moves until no further improvement is detected, at which point it commits to the best valid configuration identified during the round (e.g., maintaining balance within a specified tolerance) or reverts to the state of the prior round if no improvement is found. This reversion mechanism serves as a technical safety net to ensure only feasible, high-quality partitions are retained. Operating with linear-time complexity, this refinement stage is particularly effective when initialized with high-quality, quantum-informed starting points (e.g., VarQITE-generated partitions) rather than random seeds, allowing for accelerated local convergence and superior navigation of complex multi-objective solution spaces.

In some aspects, applying the modified FM algorithm (e.g., second modified FM algorithm) comprises: assigning an initial gain value to each node based on a partition cost function; and iteratively selecting and swapping nodes between partitions based on the improvement of the composite cost function to remove nodes from the partition with a greater total nodal weight.

The second modified FM algorithm follows a similar iterative partitioning approach as the first modified FM algorithm but introduces a modified cost function: cost=C1+p*C2, where C1 represents the original edge-weight sum and C2 represents the violation of the nodal weight balance constraint, scaled by a factor p. Nodes are selected from the overweighted partition (e.g., the one with the higher total nodal weight) and swapped to minimize the cost. Similar to the first modified algorithm, nodes are selectively swapped from the overweighted partition to the lighter partition to minimize the composite cost.

A primary technical distinction of the second modified algorithm is its treatment of constraints: rather than enforcing strict balance requirements, all node swaps are considered valid, allowing the algorithm to explore a broader region of the solution space where the balance constraint is treated as a soft penalty rather than a hard boundary. The system is configured to commit to the configuration yielding the lowest composite cost identified during a refinement round or revert to the prior state if no improvement is observed. This process iteratively continues until convergence or a predetermined iteration limit is reached, providing a flexible refinement mechanism that balances edge-cut minimization against constraint satisfaction through the scaling factor p.

At 511, the method 500 may include outputting optimized graph partitions from the modified FM algorithm for downstream applications. This post-processing step leverages the complementary strengths of quantum and classical optimization. While quantum computing identifies high-quality candidates by exploring a broad solution space, the FM algorithm provides the local refinement needed to ensure improved partitioning efficiency. This hybrid approach ensures the system avoids local minima while maintaining high computational performance. Once the final partitioned graph is obtained, it can be utilized in a variety of downstream applications, including parallel computing workload distribution, circuit design in VLSI, data clustering, and network topology optimization. The optimized partitions can be stored, visualized, or directly integrated into computational workflows for specific industrial or scientific use cases. By combining quantum-generated solutions with classical refinement techniques, this hybrid approach ensures both scalability and practicality in solving complex graph partitioning problems.

As used herein, “outputting optimized graph partitions from the modified FM algorithm for downstream applications” refers to the process of selecting and delivering one or more final graph partitions that have been refined through at least one cycle of VarQITE processing followed by modified FM algorithm post-processing. A partition is considered “optimized” when it satisfies one or more of the following termination criteria for the overall hybrid pipeline: (i) a predetermined number of quantum-classical iteration cycles Nᵢₜₑᵣ (e.g., 5 or 10 rounds as described herein) has been completed; (ii) the cost of the best partition in the current ensemble has not improved by more than a threshold margin A over the previous iteration cycle; or (iii) the nodal weight imbalance of the best partition falls within the specified constraint tolerance v (e.g., within 5% nodal weight balance). Upon satisfaction of one or more of these criteria, the method selects the lowest-cost partition(s) from the accumulated ensemble and outputs the selected partition(s) for use in downstream applications. As used herein, “downstream applications” includes, without limitation, parallel computing workload distribution, circuit design in VLSI, data clustering, network topology optimization, and nested dissection for solving sparse linear systems arising from finite element simulations. The output partitions may be stored in memory, visualized on a display, or directly integrated into computational workflows for the applicable downstream use case.

In some aspects, the method 500 may include determining final graph partitions by selecting lowest-cost partitions from an ensemble generated by multiple quantum-classical iterations. For example, the final graph partition is determined by selecting the lowest-cost configuration from an ensemble generated via multiple, iterative quantum-classical cycles. This iterative framework transforms the hybrid pipeline into a statistically robust search that systematically improves solution quality while mitigating the effects of stochastic quantum noise and gate errors inherent in near-term hardware. By aggregating candidate partitions across successive rounds of VarQITE and modified FM refinement, the method broadens the exploration of the combinatorial solution space and utilizes specific termination criteria—such as cycle counts or cost-improvement thresholds—to ensure high-confidence convergence. Consequently, this ensemble-based selection mechanism provides the reliability and precision required for performance-critical downstream applications, including nested dissection in finite element simulations and VLSI circuit partitioning.

It is understood that the method illustrated by FIG. 5 is exemplary in nature and that the steps described herein may be combined or modified to generate alternative embodiments.

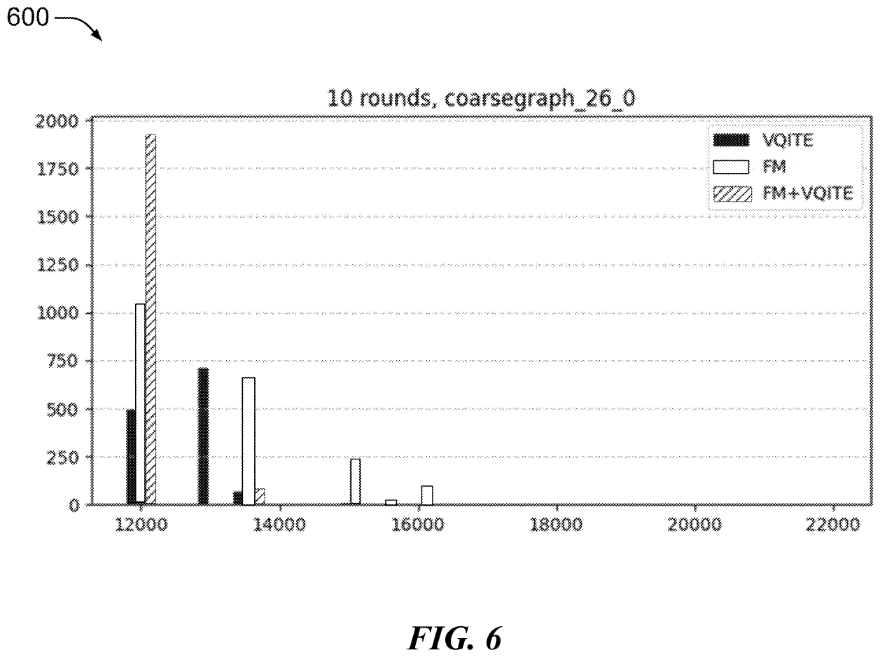

FIG. 6 illustrates example comparison results of performing VarQITE, FM, and the quantum-classical hybrid approach for solving graph partitioning problems in accordance with aspects of this disclosure. The performance of each approach is evaluated based on a multi-objective cost function comprising edge-cut cost and nodal-weight imbalance, where optimal solutions are characterized by the simultaneous minimization of both metrics. As demonstrated in example 600, the hybrid integration of VarQITE and the modified FM algorithm consistently outperforms either methodology operating independently, thereby validating the synergistic complementarity of quantum global search and classical local refinement. It should be noted that the results indicate that the hybrid methodology systematically shifts the statistical distribution of the resulting partition ensembles toward a global optimum. This demonstrates that the disclosed method does not merely identify isolated improvements but biases the entire ensemble of candidate solutions toward higher-quality regions of the solution space, ensuring a more reliable and computationally efficient convergence for complex partitioning tasks.

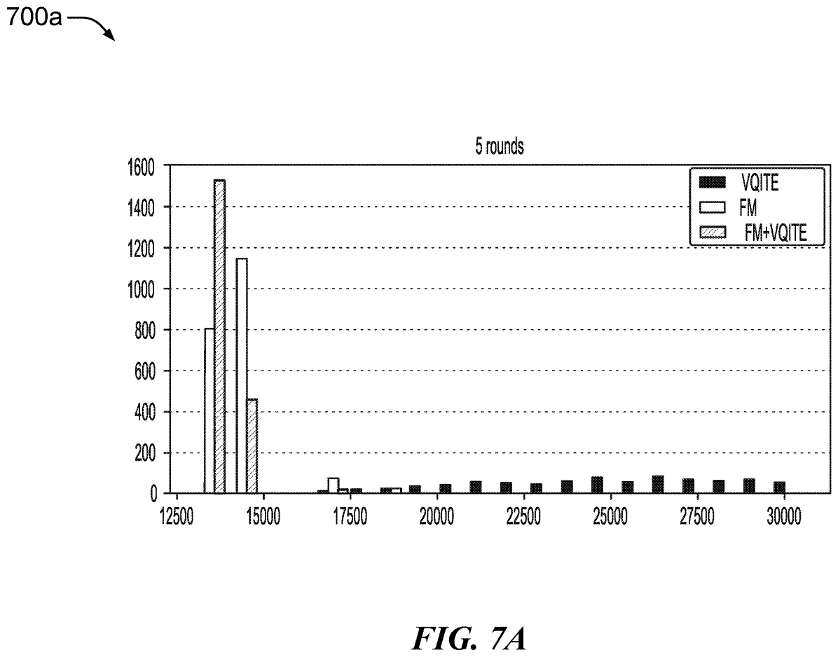

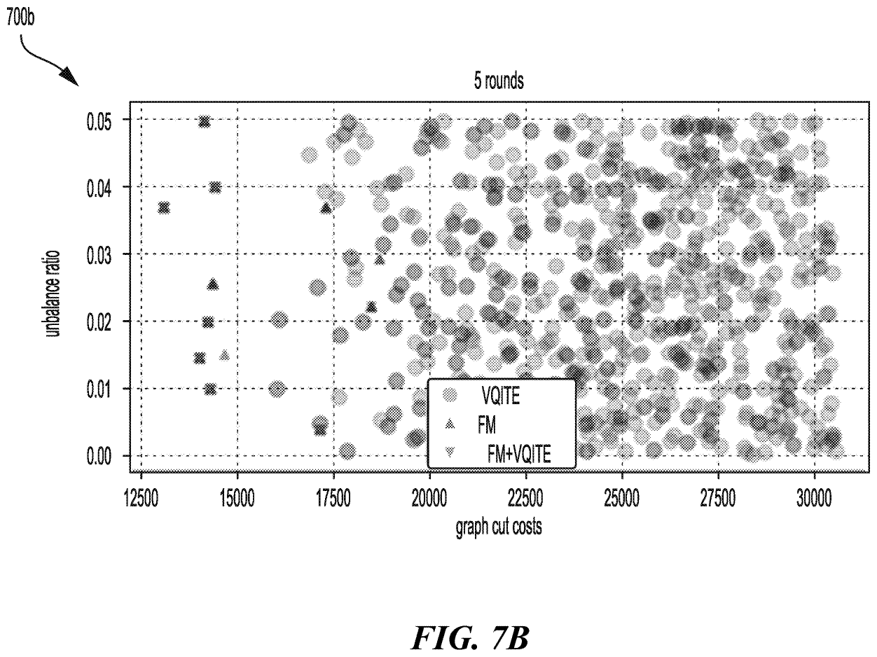

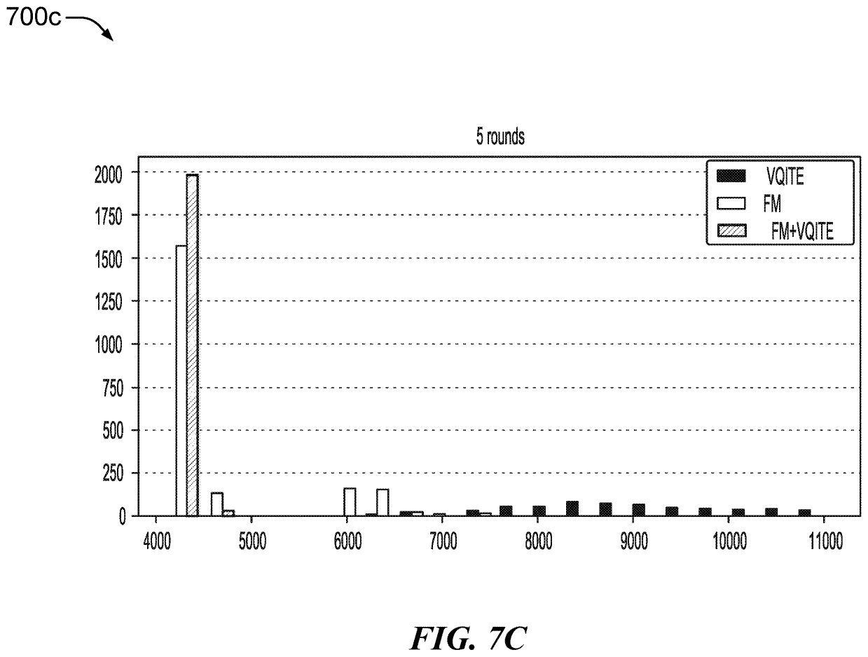

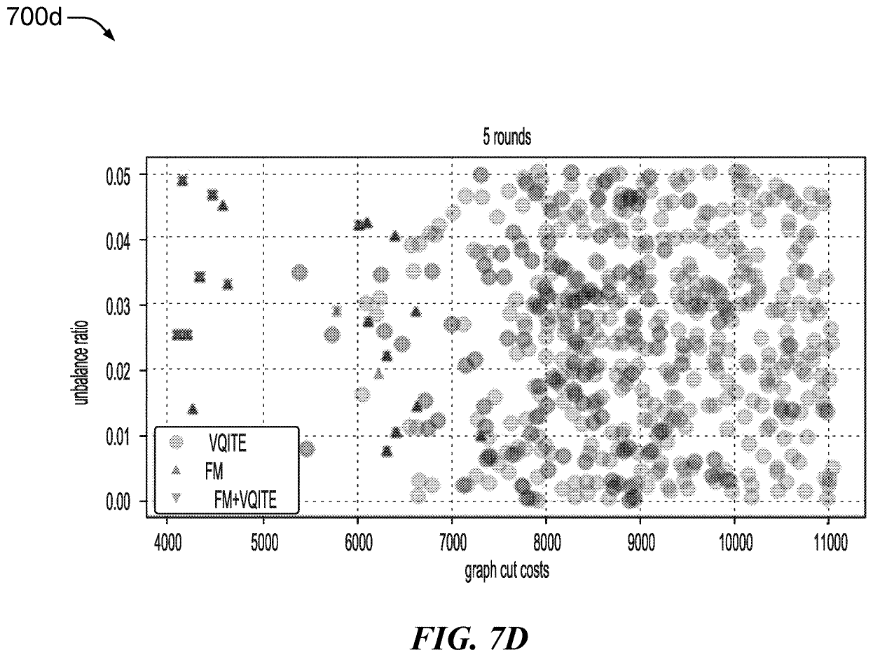

Furthermore, FIGS. 7A-7D present complementary distribution results from the same experimental setup but executed on a quantum computer using five iterations, and examples 700A-700D similarly confirm that the modified FM algorithm when combined with VarQITE outperforms both methods individually. Notably, examples 700A-700D demonstrate that the combined FM and VarQITE algorithms can generate partitions that are better than either the FM or VarQITE algorithm alone—underscoring that the synergy between the two methods is not an artifact of simulation but persists on actual quantum hardware subject to real-world noise and decoherence. The merit factor analyses across both the roof crush and blood pump simulations problem instances further reinforce this conclusion: for graphs with 18 or more nodes, the VarQITE algorithm provides solutions whose merit factors either match or are lower than those produced by the LS-GPart classical heuristic, and the merit factors show a decreasing trend on average with increasing graph size, providing confidence that the hybrid approach will yield even greater benefits as quantum hardware scales to larger numbers of qubits. The wall-clock time (WCT) measurements presented in the specification provide concrete evidence that the VarQITE-powered partitioner improves upon LS-DYNA's internal graph partitioner in most cases, with certain problem geometries suggesting comparable WCT when coarsening to a few dozen nodes as when coarsening to the production-level 10,000 nodes—a result that is particularly encouraging as a stepping-stone toward quantum utility.

FIG. 8 illustrates an example of a QIP system in accordance with aspects of this disclosure. The example QIP system 800 shown in FIG. 8 includes a control subsystem 810 that can receive a quantum program 804 from a computing device 802 that is remotely located relative to the example QIP system 800 and is functionally coupled (e.g., communicatively coupled) to the control subsystem 810. The computing device 802 can send data defining the quantum program 804 to control subsystem 810 for execution in quantum hardware 820. As is indicated by dashed lines, the computing device 802 can be external to the example QIP system 800. For example, the computing device 802 can be a user device (e.g., a classical computer) of an end-user of the QIP system 800. The control subsystem 810 can retain the quantum program 804 in one or more memory devices 812. The quantum program 804 corresponds to a defined quantum computation. The defined quantum computation can be an n-qubit computation, for example. The quantum program 804 can include a quantum circuit (and, in some cases, sub-circuits, such as a conversion component, a VarQITE component, sampling component, refinement component, and display component) representing a quantum algorithm associated with the quantum computation. Examples of the quantum algorithm include a variational quantum algorithm, a machine-learning algorithm, a Fourier transform algorithm, or the like.

The control subsystem 810 can be functionally coupled to quantum hardware 820 via multiple links 814 that permits the exchange of data and/or controls signal between the control subsystem 810 and the quantum hardware 820. The quantum hardware 820 can embody or can include one or more quantum computers. In some cases, the quantum hardware 820 embodies a cloud-based quantum computer. In other cases, the quantum hardware 820 embodies, or includes a local quantum computer. Regardless of its spatial footprint, the quantum hardware 820 includes multiple qubits 830 arranged in a particular layout. Each qubit of the qubits 830 (including the target and ancilla qubits described herein) can be coupled to an environment and/or to one another. Such coupling(s) decoheres and relaxes quantum information contained in the qubit. Thus, the quantum hardware 820 can be noisy. The type of the multiple links can be based on the type of qubits 830 used by the quantum hardware 820 for computation. In some cases, the multiple links 814 can include wireline links or optical links, or a combination of both. In other cases, the multiple links 814 can include microwave resonator devices or microwave transmission lines, or a combination of both.

The qubits 830 can include atomic qubits assembled in an atom-trap. Thus, the atomic qubits can be referred to as trapped-atom qubits. In some cases, each one of the atomic qubits can be a neutral atom. In other cases, each one of the atomic qubits can be an ion, such as an Ytterbium ion, a calcium ion, or similar ions. The atomic-qubits in such cases can be confined within an ion-trap (e.g., the trap 270 (FIG. 2)) and can be assembled in a linear arrangement (such as the linear crystal or chain 110 (FIG. 1)). In other implementations, the qubits 830 can include solid-state devices of one of several types. Such devices can be embodied in, for example, Josephson junction devices, semiconductor quantum-dots, or defects in a semiconductor material (such as vacancies in Si and Ge, or nitrogen-vacancy centers in diamond).

The control subsystem 810 can cause the quantum hardware 820 to execute the quantum circuit and/or sub-circuits as described herein. In response, the control subsystem 810 can receive measurement data 818 indicative of computation outputs, for example. Because the quantum computation can be performed in two or more qubits, a measurement outcome can be represented as a bitstring representing a particular target output state for a particular set of qubits involved in a quantum computation. The control subsystem 810 can supply at least a portion of the measurement data 818 (e.g., ancilla qubit) to components of the control subsystem 810 and/or other subsystems (e.g., post-processing subsystem 850).

The control subsystem 810 also can be functionally coupled to a post-processing subsystem 850 via a communication architecture 840. The communication architecture 840 can include wirelines links, wireless links, network devices (such as gateway devices, servers, and the like), or a combination thereof. The post-processing subsystem 850 can apply one or several post-processing techniques to measurement data 818 received from the quantum hardware 820. By applying such techniques, the post-processing subsystem 850 can generate a result 854 of a quantum computation executed by the quantum hardware. The post-processing subsystem 850 can send the result 854 (or data indicative of the result 854) to the computing device 802 and/or other computing device(s) 858. The post-processing subsystem 850 also can cause the computing device 802 to present the result 854 in a particular way. For example, the post-processing subsystem 850 can direct the computing device 802 to present a user interface including the result 854.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by those skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

In general, it is noted that the foregoing description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method for performing a quantum-classical hybrid approach for solving graph partitioning problems, the method comprising:
converting, by at least one classical processor, a graph partitioning problem with a constraint into a quadratic unconstrained binary optimization (QUBO) formulation;
encoding the QUBO formulation as a cost Hamiltonian for execution on a quantum processing unit (QPU) comprising a plurality of qubits;
applying variational quantum imaginary time evolution (VarQITE) to the QUBO formulation by executing a parameterized quantum circuit on the QPU to evolve a quantum state representing candidate solutions for the graph partitioning problem;
sampling partitions from the quantum state by measuring the plurality of qubits of the QPU in a computational basis to obtain bitstrings representing candidate graph partitions;
refining, by the at least one classical processor, the candidate solutions by inputting the sampled partitions into a modified Fiduccia-Mattheyses (FM) algorithm; and
outputting optimized graph partitions from the modified FM algorithm for downstream applications.

2. The method of claim 1, wherein the QUBO formulation comprises:
encoding a graph partitioning objective function corresponding to the graph partitioning problem;
incorporating penalty terms to enforce balance constraints on partitioning subgraphs; and
mapping binary decision variables of the QUBO formulation to qubit operators using Pauli-Z operators.

3. The method of claim 1, wherein applying the VarQITE comprises:
encoding the graph partitioning problem as a Hamiltonian minimization task;
initializing a parameterized quantum circuit;
iteratively updating circuit parameters using an imaginary time evolution process to minimize a target Hamiltonian; and
measuring the evolved quantum state to obtain a distribution of graph partition solutions.

4. The method of claim 1, wherein applying the modified FM algorithm comprises:
assigning an initial gain value to each node based on a partition cost function;
iteratively selecting and swapping nodes between partitions based on an improvement in edge cut to remove nodes from a partition with a greater total nodal weight; and
performing a check at an end of each round to enforce a weight balance constraint.

5. The method of claim 1, wherein applying the modified FM algorithm comprises:
assigning an initial gain value to each node based on a partition cost function; and
iteratively selecting and swapping nodes between partitions based on an improvement in a composite cost function to remove nodes from the partition with a greater total nodal weight.

6. The method of claim 1, further comprising:
iteratively executing multiple rounds of VarQITE partitioning followed by application of the modified FM algorithm.

7. The method of claim 1, further comprising:
determining final graph partitions by selecting a lowest-cost partition from an ensemble generated by multiple quantum-classical iterations.

8. The method of claim 1, wherein the graph partitioning problem is applied to nested dissection in finite element simulations, circuit partitioning in Very Large Scale Integration (VLSI) design, or data analysis clustering.

9. A system for performing a quantum-classical hybrid approach for solving graph partitioning problems, comprising:
a quantum processing unit (QPU) comprising a plurality of qubits;
at least one classical processor communicatively coupled to the QPU; and
at least one memory storing instructions that, when executed by the at least one classical processor, cause the system to:
convert a graph partitioning problem with a constraint into a quadratic unconstrained binary optimization (QUBO) formulation;
encode the QUBO formulation as a cost Hamiltonian for execution on the QPU;
apply variational quantum imaginary time evolution (VarQITE) to the QUBO formulation by causing the QPU to execute a parameterized quantum circuit to evolve a quantum state representing candidate solutions for the graph partitioning problem;
sample partitions from the quantum state by measuring the plurality of qubits of the QPU in a computational basis to obtain bitstrings representing candidate graph partitions;
refine the candidate solutions by inputting the sampled partitions into a modified Fiduccia-Mattheyses (FM) algorithm executed by the at least one classical processor; and
output optimized graph partitions from the modified FM algorithm for downstream applications.

10. The system of claim 9, wherein the QUBO formulation comprises:
encoding a graph partitioning objective function corresponding to the graph partitioning problem;
incorporating penalty terms to enforce balance constraints on partitioning subgraphs; and
mapping binary decision variables of the QUBO formulation to qubit operators using Pauli-Z operators.

11. The system of claim 9, wherein applying the VarQITE comprises:
encoding the graph partitioning problem as a Hamiltonian minimization task;
initializing a parameterized quantum circuit;
iteratively updating circuit parameters using an imaginary time evolution process to minimize a target Hamiltonian; and
measuring the evolved quantum state to obtain a distribution of graph partition solutions.

12. The system of claim 9, wherein applying the modified FM algorithm comprises:
assigning an initial gain value to each node based on a partition cost function;
iteratively selecting and swapping nodes between partitions based on an improvement in edge cut to remove nodes from a partition with a greater total nodal weight; and
performing a check at an end of each round to enforce a weight balance constraint.

13. The system of claim 9, wherein applying the modified FM algorithm comprises:
assigning an initial gain value to each node based on a partition cost function; and
iteratively selecting and swapping nodes between partitions based on an improvement in a composite cost function to remove nodes from a partition with a greater total nodal weight.

14. The system of claim 9, wherein the at least one classical processor is further configured to:
iteratively execute multiple rounds of VarQITE partitioning followed by application of the modified FM algorithm.

15. The system of claim 9, wherein the at least one classical processor is further configured to:
determine a final graph partition by selecting a lowest-cost partition from an ensemble generated by multiple quantum-classical iterations.

16. The system of claim 9, wherein the graph partitioning problem is applied to nested dissection in finite element simulations, circuit partitioning in VLSI design, or data analysis clustering.

17. A non-transitory computer-readable medium storing thereon computer executable instructions that, when executed by at least one classical processor communicatively coupled to a quantum processing unit (QPU) comprising a plurality of qubits, cause a computing system to:
convert a graph partitioning problem with a constraint into a quadratic unconstrained binary optimization (QUBO) formulation;
encode the QUBO formulation as a cost Hamiltonian for execution on the QPU;
apply variational quantum imaginary time evolution (VarQITE) to the QUBO formulation by causing the QPU to execute a parameterized quantum circuit to evolve a quantum state representing candidate solutions for the graph partitioning problem;
sample partitions from the quantum state by measuring the plurality of qubits of the QPU in a computational basis to obtain bitstrings representing candidate graph partitions;
refine the candidate solutions by inputting the sampled partitions into a modified Fiduccia-Mattheyses (FM) algorithm executed by the at least one classical processor; and output optimized graph partitions from the modified FM algorithm for downstream applications.

18. The non-transitory computer-readable medium of claim 17, wherein applying the VarQITE comprises:
encoding the graph partitioning problem as a Hamiltonian minimization task;
initializing a parameterized quantum circuit;
iteratively updating circuit parameters using an imaginary time evolution process to minimize a target Hamiltonian; and
measuring the evolved quantum state to obtain a distribution of graph partition solutions.

19. The non-transitory computer-readable medium of claim 17, wherein applying the modified FM algorithm comprises:
assigning an initial gain value to each node based on a partition cost function;
iteratively selecting and swapping nodes between partitions based on an improvement in edge cut to remove nodes from a partition with a greater total nodal weight; and
performing a check at an end of each round to enforce a weight balance constraint.

20. The non-transitory computer-readable medium of claim 17, wherein applying the modified FM algorithm comprises:
assigning an initial gain value to each node based on a partition cost function; and
iteratively selecting and swapping nodes between partitions based on an improvement in a composite cost function to remove nodes from the partition with a greater total nodal weight.
